(19) United States
(12) Patent Application Publication
(10) Pub. No.: US 2004/0197536 A1
(43) Pub. Date: Oct. 7, 2004

(54) Heat applied graphics and method

(76) Inventor: Brett A. Stahl, Grosse Pointe Farms, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 10/770,144

(22) Filed: Feb. 2, 2004

Related U.S. Application Data
(63) Continuation-in-part of application No. 09/931,569, filed on Aug. 16, 2001, now abandoned.

(51) Int. Cl. B05D 1/36; B41M 3/12

(52) U.S. Cl. 428/195.1; 427/146

(57) ABSTRACT

Graphics for heat sealing attachment to fabrics and hard surfaces are made by flooding a release paper with screen printing ink and then covering the ink with a thermally responsive adhesive after which the ink and adhesive are kiss-cut in reverse to the release paper preferably by a laser cutter whose power is set to singe the cut at the adhesive to highlight the indicia and facilitate weeding; the ink flooding may be arranged in multiple congruent patches spaced from the edges of the release paper so that upon cutting the paper into sub-sheets, uniform margins are provided about each patch, and the indicia may be accurately positioned in each patch.

### CROSS-REFERENCE TO RELATED APPLICATIONS

This application is a continuation-in-part of U.S. application Ser. No. 09/931,569 filed Aug. 16, 2001, the entire disclosure of which in hereby incorporated by reference.

### BACKGROUND OF THE INVENTION

1. Field of the Invention

This invention relates to graphics which are heat-sealed to fabrics and hard surfaces, and to methods of making such graphics.

2. Background

Heat-applied graphics have been widely used to apply a variety of indicia onto many different types of substrates which include for example fabrics and hard surfaces. Such indicia include for example trademarks, designs, patterns, numerals, names, logos, and the like. In addition, heat-applied graphics have found particular use on sports jerseys, jackets and the like. Moreover, graphics incorporating trademark indicia or licensed characters have also become increasingly popular.

Although these processes work well, there has been a continuing need to reduce the cost thereof and to speed the imprinting operations which are used to apply such graphics. The release sheet upon which the indicia are carried for positioning and applying the indicia to fabrics and hard surfaces has in some instances been as costly as the indicia themselves. This is because the release sheet has been made of Mylar® or other smooth plastic sheet material whose cost is high and which is durable only in rolled form. Mylar® is used because it is transparent and allows visual positioning of the graphics on the article being decorated.

In addition, where the indicia consist of, for example, letters and numbers arranged in a predetermined pattern, it was a time-consuming operation for the imprinter to position the letters and numerals on the garment to be decorated before heat-sealing the letters and numbers thereto.

### SUMMARY OF THE INVENTION

The present invention overcomes one or more problems of the prior art by providing in one embodiment a method of making graphics to be heat transferred to a substrate. The graphics made by the method of the invention may be formed of multiple letters and/or numerals accurately positioned on a release sheet such as paper or Mylar® release sheets. The present invention advantageously allows the positioning of the release sheet on a substrate to set the position of the graphics of the invention such that the imprinter will be able to transfer indicia to the surface to be decorated with the indicia appearing in the location desired. Moreover, the method of the invention allows indicia to be accurately located with respect to each other and with respect to the margins of the release sheet.

The method of the invention comprises flooding a release surface of a release sheet with a heat transfer ink to form one or more ink patches accurately positioned with respect to the margins of the release sheet. Typically, the release sheet has a release coating on the release surface that is flooded with a heat transfer ink. At this stage of the method, the one or more ink patches will have a contacted surface in contact with the release sheet (or the release coating), and an exposed surface not in contact with the release sheet or release coating. The flooding of the release sheet (with or without the release coating) may be accomplished by utilizing conventional techniques such as screen printing, spraying, and the like. A plurality of such patches may be formed on each release sheet with the patches being spaced from each other and from the margins of the release sheet. This accurate positioning of the patches allows subsequently cutting through the release sheet to produce identical sub-sheets.

The method of the present invention further comprises applying a heat-sealable adhesive to the exposed surface of the ink patch or patches on the release sheet while the ink is still a liquid to form adhesive-coated ink patches on the release sheet. Such adhesive will serve to adhere the graphic to be formed to the fabric or hard surface to be decorated with the graphic made by the method of the invention. The graphic of the invention is then reversely kiss-cut about the one or more ink patches through the adhesive and ink layers to the release coated surface of the release sheet to form unweeded indicia on the release sheet. Preferably, this kiss-cutting is accomplished using a laser whose power input is adjusted to slightly singe the cut thereby outlining the graphic design and facilitating weeding of unwanted ink layer from around the indicia. Finally, the unwanted material is weeded from each patch to form the graphic of the invention.

In a variation of the invention, a paper or Mylar® release sheet has a plurality of discrete ink patches deposited thereon in precisely controlled relation to each other and to the margin of the release sheet. An adhesive layer is deposited on the exposed surface of the patches before the ink solidifies, and the indicia is then kiss-cut in reverse from each patch. The release sheet is then cut into congruent sub-sheets. Either before or after this cutting unwanted portions of the ink layer may be weeded away from the graphic design. As a result, the cost of producing heat-sealable graphics can be substantially reduced while graphics equal or better than that heretofore realized may be enjoyed.

### BRIEF DESCRIPTION OF THE DRAWINGS

FIG. 1 is a plan view of a release sheet having graphics kiss cut in reverse thereon in accordance with my invention;

FIG. 2 is a schematic rendition of the method by which the graphics are made;

FIG. 3 is a cross-sectional view taken along line 3-3 of FIG. 2 but with the conveyor belt omitted;

FIG. 4 is a cross-sectional view taken along line 4-4 of FIG. 2 but with the conveyor belt omitted;

FIG. 5 is a cross-sectional view through a laser kiss-cutting of the ink and adhesive layers; and

FIG. 6 is a cross-sectional view through ink and adhesive layers as unwanted material is being removed.

### DETAILED DESCRIPTION OF THE PREFERRED EMBODIMENTS

Reference will now be made in detail to presently preferred compositions or embodiments and methods of the invention, which constitute the best modes of practicing the invention presently known to the inventors.

In one embodiment, the present invention provides a method of making graphics to be heat transferred to a substrate. Suitable substrates to which the graphics may be transferred include but are not limited to fabrics and hard surfaces. The method of the invention comprises flooding a release surface of a release sheet with a heat transfer ink to form one or more ink patches. As used herein “ink patch’ is a region of the release sheet coated with ink regardless of its shape. The method of the present invention further comprises applying a heat-sealable adhesive to the exposed surface of the one or more ink patches on the release sheet while the ink is still a liquid (i.e., in the liquid stage) to form adhesive-coated ink patches on the release sheet. Next, the adhesive-coated ink patches are then reversely kiss-cut about the patches through the adhesive and ink layers to the release coated surface of the release sheet to form unweeded indicia on the release sheet. “Indicia” as used herein refers to actual decoration or marking that is transferred to a surface, i.e., trademarks, designs, patterns, numerals, names, logos, and the like. Moreover, as used herein “graphic” and “indicia” will be used interchangeably as both are the decoration that is transferred to a substrate. The method of the invention is further characterized in that the release sheet is adhered less strongly to the ink than the adhesive is adhered to the ink when the graphic is applied to a substrate such that the release sheet may be peeled away from the ink after the graphic is applied to the substrate. This latter characterization of the invention is evident from the fact that the release sheet may be peeled away from the graphic after the graphic is adhered to a surface.

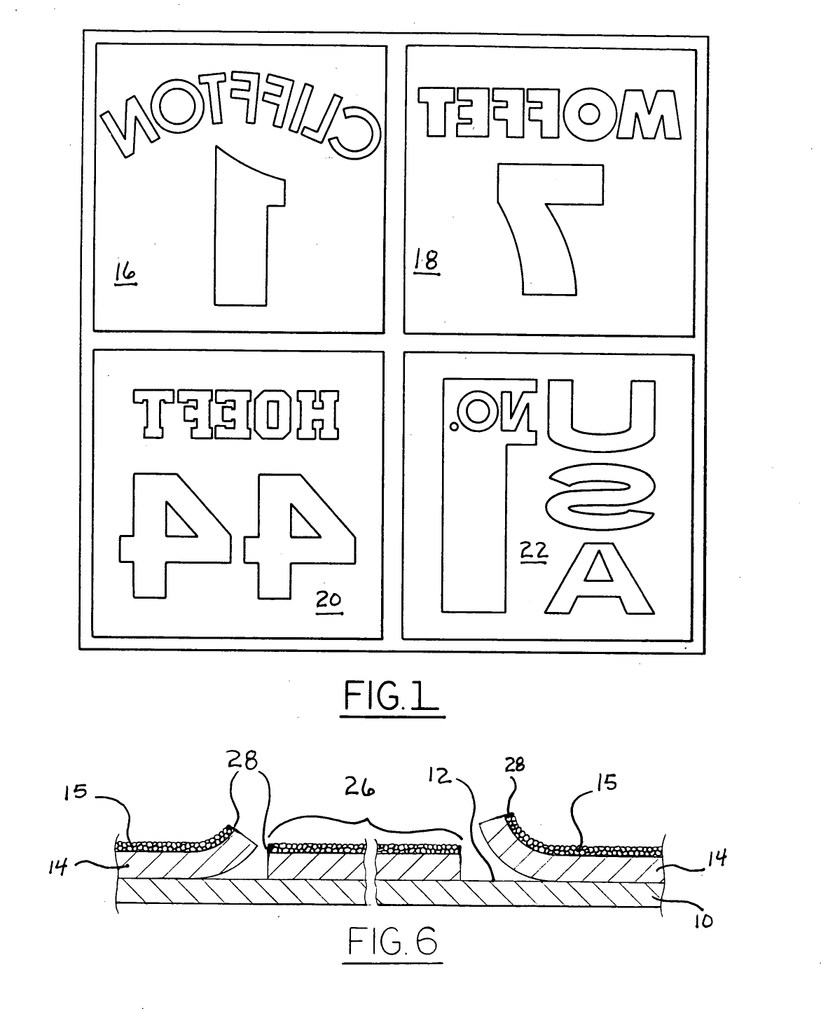

With reference to FIGS. 1 and 6, a paper or Mylar® release sheet 10 is coated on one surface 12 with a release agent. The side of the release sheet that is coated with the releasing agent is referred to as the release surface. Release paper suitable for this method is sold under the name Trans-French T75/Transfer T75. This is a well-known release/transfer paper manufactured in France but available from many screen printing equipment or ink suppliers including Union Ink Company of 453 Broad Avenue, Ridgefield, N.J. 07657. Other release papers may also be available for utilization in practicing this method.

The release surface 12 of the release sheet 10 is flooded by a water-based or solvent-based heat transfer type ink 14. An ink suitable for this purpose is a high opacity screen printing ink manufactured by Union Ink. This ink is a plastisol commonly used in screen printing.

In a preferred embodiment, the ink is screen printed onto the surface 12 of the release paper or sheet in a plurality of congruent patches, four being shown in FIG. 1 at 16, 18, 20 and 22. A greater or lesser number of patches may be formed on the release sheet. The ink may be of various colors as required by the imprinter. The patches are preferably spaced apart a distance of one inch, and spaced one-half inch from the edges of the release sheet and arranged such that when the release sheet 10 is cut apart between the patches, the margins of the sub-sheets will be uniformly one-half inch around each patch.

Following flooding of the release surface of the release sheet 10, and before the ink solidifies, the exposed surface of the ink layer 14 is coated with a heat sensitive adhesive such as a granular type formulated using PVC or other suitable heat-responsive adhesive 15. The adhesive may be varied in accordance with the type of surface to which the graphics are to be applied. For example, polyvinyl chloride adhesive is suitable for use with cottons and polyesters, while a different type of adhesive would perhaps be more suitable for other fabrics or surfaces, for example, such as nylons. Suitable adhesives include co-polyester powder adhesives commercially available from Bostick, 211 Boston Street, Middleton, Mass. A number of similar adhesives suitable for the method of the invention are also commercially available from other sources.

Following the application of the adhesive 15, and solidification thereof, the ink patches are kiss-cut in reverse (i.e., the patches are cut from the adhesive side in a pattern which is the reverse of the indicia to be applied when viewed from this adhesive side) through the adhesive and ink layers to the release surface 12 of the release paper 10 as best shown in FIGS. 5 and 6. This kiss-cutting is preferably done utilizing a laser cutter. The power to the laser cutter is adjusted to slightly singe the edges of the cut ink layers adjacent the adhesive layer. In the preferred embodiment, it is understood that no singeing appears on the edge of the ink layers adjacent the release paper 10. The singeing discolors the ink layer slightly only adjacent the adhesive layer thereby facilitating weeding of unwanted material from around and within the indicia. It is to be noted that, if, for example, a knife is used to cut the indicia in the ink layer, the benefit of the singeing will not be obtained. This singeing does not appear in the final product as applied to the fabric or hard surface because the singed edge is against such surface. The laser cutter is schematically shown at 24 while the laser itself is depicted schematically at 26 in FIG. 5.

The kiss-cutting of the indicia in patches 16, 18, 20 and 22 may be accomplished by the laser or the knife on a cutting table under the control of a computer (not shown). The layout and spacing of the indicia may be accurately programmed into the computer to provide for the location of the indicia with respect to the edges of the patches, the spacing of the letters, numerals or designs with respect to each other within each of the graphics and with this programmed into the computer, the kiss-cutting may be carried out to produce an accurately positioned and pre-spaced indicia to provide the final graphics product.

Following kiss-cutting of the patches, the cutter may be utilized to cut the release paper 10 into individual sub-sheets, each containing the desired indicia. Either before or after such cutting, the weeding away of unwanted material may be effected as schematically shown in FIG. 6 where the central portion 26 is to remain on the transfer sheet while portions to the right and left thereof, as shown in FIG. 6, are peeled away during the weeding. The singed edges of the indicia are schematically indicated at 28 in FIG. 6.

Because patches 16, 18, 20 and 22 have been accurately positioned to provide uniform margins of release sheet around each patch after the release paper is cut up, and because the graphics are accurately positioned on each patch, and the indicia are accurately positioned and spaced apart in each patch, the imprinter need only position the release sheet uniformly on each garment or the like to be decorated, and then the heat sealing operation performed, and thereafter the release sheet peeled away, to result in the graphics being accurately transferred and positioned on the surface being imprinted. For a series of graphics made by the method of the invention, the positioning of the graphic on the release sheet is of sufficient accuracy (i.e., reproduceable) that the differences in the distances from each margin for an analogous position on each graphic in the series of graphics are less than 5 mm (that is for the same type of graphic the variation in the positioning is less than 5 mm). More preferably, the differences in the distances from each margin for an analogous position on each graphic in the series of graphics are less than 3 mm, and most preferably, the differences in the distances from each margin for an analogous position on each graphic in the series of graphic s are less than 1 mm. As set forth above, the accurate positioning of the graphic on the release sheet allows for the alignment of the release sheet on a substrate (fabric or hard surface) to set the alignment of the graphic on the substrate. This advantageously reduces the expense of the graphic transferring process and also allows the use of opaque release sheets since the positioning of the graphic on the substrate need not be observed.

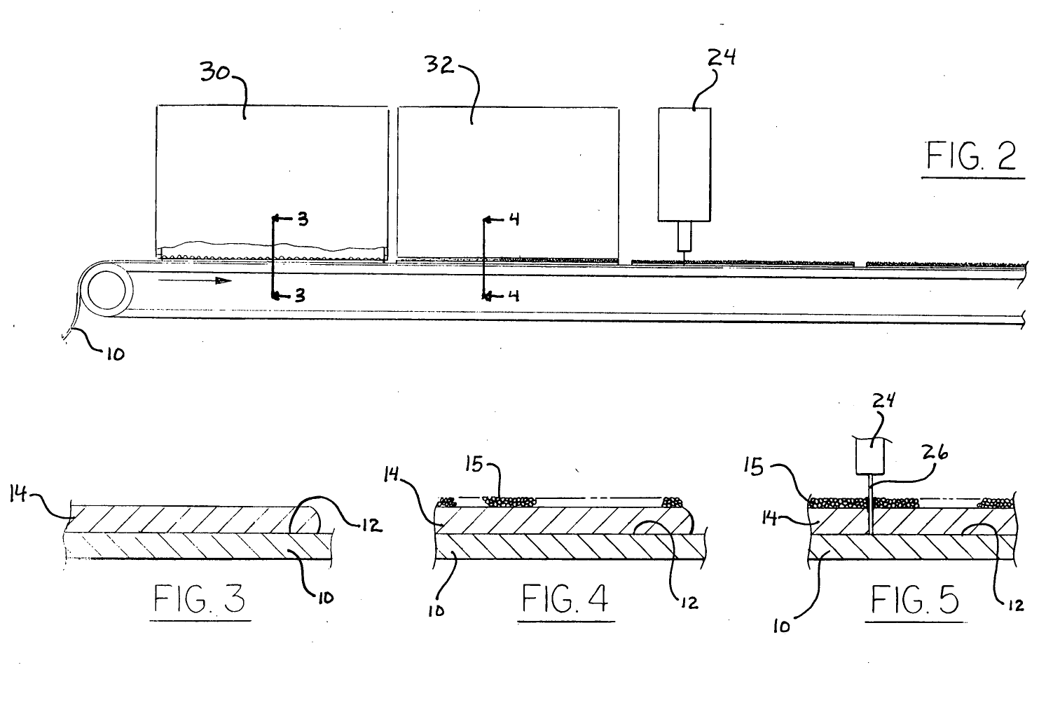

The entire production of the graphics may be carried out in a production environment using a conveyor system schematically shown in FIG. 2, or transfer frames within which the transfer sheet may be mounted prior to the screen printing thereof and application of the adhesive. The conveyor or transfer frames can be utilized to move the product during its manufacture from a screen printing station shown schematically at 30 where the ink is applied to the transfer sheet 10 and the conveyor can then move the paper to the adhesive sprinkling or coating station 32, and finally the paper is moved beneath the cutter 24 where the kiss-cutting of the indicia is carried out. Between stations 32 and the kiss-cutting operation, the ink layer will be solidified.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making a graphic for heat sealing application to fabrics and hard surfaces comprising:
flooding a release surface of a release sheet with a heat transfer ink in a liquid stage to form one or more patches on the release sheet;
applying a thermoplastic adhesive to the release sheet while the ink is still in the liquid stage;
solidifying the ink with the adhesive applied thereon; and
kiss-cutting about the one or more patches through the adhesive and ink to the release surface of the release sheet wherein the release sheet is adhered less strongly to the ink than the adhesive is adhered to the ink when the graphic is applied to a substrate such that the release sheet may be peeled away from the ink after the graphic is applied to the substrate.

2. The method of claim 1 wherein the ink is a screen printing ink.

3. The method of claim 1 wherein the ink is applied as discrete congruent patches.

4. The method of claim 1 wherein the flooding of the release surface by ink is by screen printing the ink thereon.

5. The method of claim 1 wherein the ink comprises a water or solvent based heat transfer type ink.

6. The method of claim 1 wherein the step of kiss cutting comprises laser cutting with a laser, the laser being supplied with sufficient power to singe the ink along a cut line adjacent the adhesive to render the line readily visible for weeding.

7. The method of claim 1 wherein the release sheet comprises paper with a release coating on one surface thereof.

8. The method of claim 1 wherein the graphic is positioned reproducibly on the release sheet such that differences in the distances from each margin for an analogous position on each graphic in a series of graphics are less than 5 mm.

9. The method of claim 1 wherein the graphic is positioned reproducibly on the release sheet such that differences in the distances from each margin for an analogous position on each graphic in a series of graphics are less than 3 mm.

10. The method of claim 1 wherein the graphic is positioned reproducibly on the release sheet such that differences in the distances from each margin for an analogous position on each graphic in a series of graphics are less than 1 mm.

11. The method of claim 1 wherein the kiss-cutting is performed successively on a plurality of patches on each release sheet.

12. The method of claim 1 wherein the flooding of the release sheet with ink is by simultaneously screen printing a plurality of patches on the release sheet.

13. The method of claim 1 further comprising weeding unwanted material from each of the one or more patches.

14. A graphic made by the method of claim 1.

15. A method of making aligned and pre-spaced heat transfer indicia on a release sheet for application to fabrics or hard surfaces, the method comprising:
flooding the release surface of a release sheet with a plurality of discrete congruent patches of heat transfer ink in the liquid stage, such patches being arranged on the sheet and separated from each other that the sheet may be subsequently cut apart into congruent sub-sheets with the patches congruently arranged thereon;
applying a thermoplastic adhesive to the release surface of the release sheet while the ink is still in the liquid stage;
solidifying the ink with the adhesive applied thereon;
kiss-cutting through the adhesive and ink in each patch to said release surface of the release sheet to form indicia arranged in the patches; and
cutting through the release sheet into a plurality of congruent sub-sheets having heat transfer indicia thereon;

16. The method of claim 15 further comprising weeding unwanted material from each patch of the plurality of patches.

17. The method of claim 15 wherein the step of kiss-cutting through the adhesive and the ink is so arranged with respect to the patches that the distance between the margins of the sub-sheets and the patches is equal.

18. The method of claim 15 wherein the indicia kiss-cut in each patch comprises letters, numbers, or combinations thereof, spaced in predetermined relation to each other.

19. A method of making a readily weedable heat applied graphic comprising:
flooding a release surface of a release sheet with a heat transfer ink in a liquid stage to form a plurality of patches on the release sheet;
applying a thermoplastic adhesive to the release sheet while the ink is still in the liquid stage;
solidifying the ink with the adhesive applied thereon; and
kiss-cutting through the adhesive and ink to said release surface of the release sheet with a laser cutter; and
adjusting the power to singe the cut edges of the ink whereby they are readily visible for weeding wherein the release sheet is adhered less strongly to the ink than the adhesive is adhered to the ink when the graphic is applied to a substrate such that the release sheet may be peeled away from the ink after the graphic is applied to the substrate.
